(19) United States
(12) Patent Application Publication
(10) Pub. No.: US 2009/0269722 A1
(43) Pub. Date: Oct. 29, 2009

(54) Pivot for a tooth with an apical end for the protection against the initiation of radicular cracks and breaks

(75) Inventor: Pierre Malek, Key Biscayne, FL (US)

Correspondence Address: HARNESS, DICKEY & PIERCE, P.L.C., P.O. BOX 828, BLOOMFIELD HILLS, MI, 48303, US

(73) Assignee: Pierre Malek, Key Biscayne, FL (US)

(21) Appl. No.: 12/404,704

(22) Filed: Mar. 16, 2009

(30) Foreign Application Priority Data
Mar. 18, 2008 (FR) 0851737

(51) Int. Cl. A61C 5/08

(52) U.S. Cl. 433/221

(57) ABSTRACT

The present application relates to a radicular pivot wherein the apical end of the pivot has a hemispheric end with a continuous variation in the curvature between the cylindro-conical part and the apical end. The invention also relates to a drill for the preparation of the radicular chamber intended to receive such a pivot, as well as the system composed of a pivot and the matching drill.

### CROSS-REFERENCE TO RELATED APPLICATIONS

This application claims priority to French patent application Ser. No. 08/51737, filed Mar. 18, 2008, which is corporated herein by reference.

### BACKGROUND AND SUMMARY

The present invention relates to the field of tooth pivots. A tooth pivot is composed of a three to twenty millimeters long cylindrical structure, which can be crowned. The tooth pivot is intended to be anchored at the level of the root of the tooth, using dental cement. The pivot can have an external thread and be substantially vertically screwed in the region of the radicular canal, so as to form a removable link between the anchoring pivot and the root of the tooth.

The patent EP0305934 is known, which describes a tooth pivot having a rod, with the apical part of the pivot being cylindrical, which is followed by a tapered cervical part extended by a head adjacent to the tapered part. The head is used for restoring, in a composite material or an amalgam, a stump intended to receive a tooth crown. The section of the head is not circular which better matches the shape of a natural tooth than if it were of a circular shape, but it requires to be able to orient the pivot when it is positioned in the radical canal after an endodontic preparation thereof, depending on the dental arch.

The rod is completely smooth. The apical part of the pivot is very retentive whereas the cervical part is a robust base for the restoration of the stump while providing a solid rest on the natural crown. Pivots having a threaded rod on a part of the length thereof are also known. The American patent U.S. Pat. No. 4,334,865 describes such a pivot having a threaded end, which makes it possible to anchor it, using dental cement or a sealing paste. This pivot can be made of titanium or of a synthetic material.

The problem arising from such pivots is that of stresses exerted by the pivot on the root during the chewing of food, which can cause the unsealing, thus resulting in corono-radicular breaks. During the chewing, the teeth are submitted to two types of stresses, compression and shearing stresses. The compression stresses are more particularly exerted on the back teeth (premolar and molar teeth). The shearing stresses are mainly exerted on the front teeth (incisive and canine teeth). The teeth restored by the positioning of one or several radicular pivot(s) are particularly sensitive to such stresses.

The radicular pivots are sealed in the root through a smooth, ribbed or threaded rod. The pivots of the state of the art have a conical pointed end (refer to FIG. 1) forming a 120° to 160° slope or a flat point end (refer to FIGS. 2 and 3), to be accommodated in a chamber provided in the root with a drill having a matching shape. The conical or flat point ends have annular sharp edges at the crossing of the conical or cylindrical smooth part and the conical or plane end. During the motions caused by the shearing and compression stresses, the edges exert a tension on the inner surface of the root which can cause initiations of cracks or breaks, through a wedge or a shearing effect.

The present invention aims at remedying such drawbacks by providing an apical shape of the pivot without any annular edge with a hemispheric end having the shape of a joint. For this purpose, the invention, in its broadest sense, relates to a radicular pivot characterised in that the apical end of the pivot has a hemispheric end with a continuous variation of the curvature between the cylindrical or conical part, and the distal end.

According to a variant, the end of the apical end of the pivot has an ogival shape. According to another variant, the end of the apical end of the pivot has a spheroidal shape. Preferably, the apical end of the pivot has a hemispheric end, the radius of curvature of which is never less than 0.1 millimeter.

The invention also relates to a system including a drill for the preparation of a radical chamber intended to receive a radical pivot, and a pivot characterised in that the end of the drill and the pivot have matching hemispheric and homothetic shapes. The invention further relates to a drill for the preparation of a radicular chamber characterised in that the end thereof has a hemispheric shape and more precisely either:

an ogival shape,

a spheroidal shape,

a hemispheric shape, the radius of curvature of which is never less than 0.1 millimeter.

### BRIEF DESCRIPTION OF DRAWINGS

The invention will be better understood upon reading the detailed following description and referring to the appended drawings wherein:

FIGS. 1 to 3 show diagrammatic views of a pivot according to the prior art; and

FIGS. 4 to 7 show perspective views of variants of embodiments of the invention.

### DETAILED DESCRIPTION

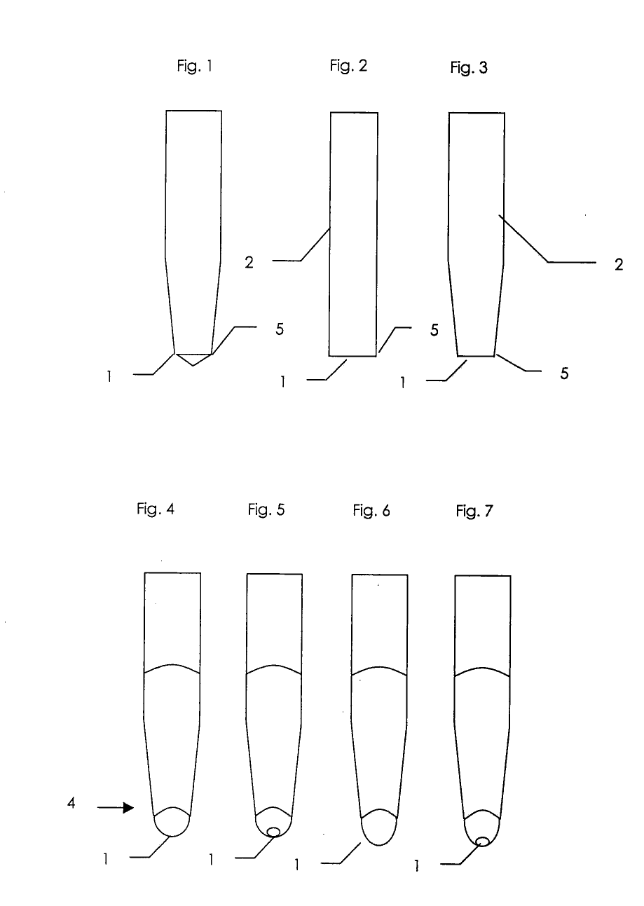

FIG. 1 shows a known exemplary embodiment of a pivot having an apical end (1) having a conical shape. FIG. 2 shows a variant of the state of the art in which the pivot has a cylindrical body (2) with a plane apical end (1). FIG. 3 shows a variant of the state of the art in which the pivot has a tapered body (2) with a plane apical end (1).

In the various embodiments of the prior art, the pivot has a line (5) which forms an annular sharp edge with a break of slope between the upstream part and the downstream part. Such annular sharp edge exerts stresses on the inner surface of the root which can cause over time the unsealing, thus resulting in cracks and breaks.

FIG. 4 shows a diagrammatic view of a pivot according to the invention. It is composed of a rod (2) made of titanium. The general shape of the rod (2) is conical with a section decreasing towards the apical end of the pivot (1). The distal end shows, in a known way, crown anchoring means. The apical end of the pivot extends the rod without a break of slope and without any annular edge, by means of a hemispheric part having substantially the shape of a portion of a sphere having a radius of curvature of 0.5 millimeter and extending on slightly less than half a sphere, so as to extend the cylindrical or conical end of the rod without any break of slope.

FIGS. 5 to 7 show perspective views of a variant wherein the apical point end of the pivot has a truncated hemispheric shape with a plane distal end (flat section), or an ogival distal end (FIG. 6) or ogival and plane distal end (FIG. 7).

1. A radicular pivot comprising a apical end of the pivot has a truncated hemispheric end with a plane distal end showing a continuous variation of the curvature between the cylindro-conical part and the apical end.

2. A radicular pivot according to claim 1, wherein the apical end of the pivot has a truncated ogival shape with a plane distal end.

3. A radicular pivot according to claim 1, wherein the apical end of the pivot has a truncated ovoid shape with a plane distal end.

4. A radicular pivot according to claim 1, wherein the apical end of the pivot has a truncated spheroidal shape with a plane distal end.

5. A radicular pivot according to claim 1, wherein the apical end of the pivot has a hemispheric end, the radius of curvature of which is never less than 0.1 millimeter.

6. A system comprising a radicular pivot according to claim 1 and a drill for the preparation of a radicular chamber intended to receive said pivot, wherein the apical ends of said pivot and said drill have truncated hemispheric shapes with matching plane distal ends.

7. A drill for the preparation of a radicular chamber, the drill comprising an end having a truncated hemispheric shape with a plane distal end.

8. A drill for the preparation of a radicular chamber, the drill comprising an end having a truncated ogival shape with a plane distal end.

9. A radicular drill according to claim 7, wherein the end of said drill has a truncated spheroidal shape with a plane distal end.

10. A radicular drill according to claim 8, wherein the end of said drill has a truncated hemispheric end with a plane distal end, the radius of curvature of which is never less than 0.1 millimeter.
